(19) United States
(12) Patent Application Publication
(10) Pub. No.: US 2025/0149273 A1
(43) Pub. Date: May 8, 2025

(54) SWITCH MECHANISM CONVENIENT FOR ADJUSTMENT DURING HOLDING, AND EQUIPMENT USING SWITCH MECHANISM

(71) Applicant: Shenzhen Weiteshijia Technology Co., Ltd, Shenzhen (CN)

(72) Inventor: Yan Chen, Huilai (CN)

(21) Appl. No.: 19/006,447

(22) Filed: Dec. 31, 2024

(30) Foreign Application Priority Data
Oct. 30, 2024 (CN) 202422623602.4

(51) Int. Cl. H01H 19/14; H01H 19/03; H01H 19/04

(52) U.S. Cl. CPC H01H 19/14; H01H 19/03; H01H 19/04; H01H 2231/012

(57) ABSTRACT

A switch mechanism convenient for adjustment during holding and equipment using the switch mechanism are provided. The switch mechanism includes: a connecting member, wherein the connecting member is configured to connect two or more components, for originally separated components to be integrally connected, and a specially-shaped shaft is arranged on the connecting member in an integrated connection manner; a code switch, which includes a fixed end and a rotating end, wherein the code switch sleeves the outer circumference of the specially-shaped shaft, and the fixed end is kept in fixed connection with the specially-shaped shaft; the rotating end is rotationally connected to the specially-shaped shaft; and a rotating ring, which is a ring-shaped component sleeving the outer circumference of the specially-shaped shaft.

### TECHNICAL FIELD

The present disclosure relates to the technical field of switch mechanisms, and specifically, to a switch mechanism convenient for adjustment during holding, and equipment using the switch mechanism.

### BACKGROUND

A switch is an element used in electronic equipment to contact, switch off, convert a circuit, or to adjust a magnitude of current.

Since most handheld products are held in a hand of a user during use, if a working state of a set of equipment needs to be adjusted during use, the user often has to adjust the working state under the help of the other hand, which makes the operation very inconvenient, especially when the other hand is not free. This may affect the execution of the adjustment.

In addition, most commonly used adjustment switches are push-type button switches, which cannot achieve fine adjustment through a point-contact switch element, and the adjustment sensitivity is not ideal. A push failure or a phenomenon that a button is continuously pushed often occurs. Especially for touch switches, its adjustment accuracy is even less ideal.

### SUMMARY

The present disclosure aims to provide a switch mechanism convenient for adjustment during holding, and equipment using the switch mechanism. When using this switch mechanism, handheld equipment can be conveniently adjusted, and even can be steplessly adjusted at high precision, which effectively solves the shortcomings in the existing technology.

To achieve the above objectives the present disclosure provides the following technical solution: A switch mechanism convenient for adjustment during holding includes: a connecting member, wherein the connecting member is configured to connect two or more components, for originally separated components to be integrally connected, and a specially-shaped shaft is arranged on the connecting member in an integrated connection manner; a code switch, which includes a fixed end and a rotating end, wherein the code switch sleeves an outer circumference of the specially-shaped shaft, and the fixed end is kept in fixed connection with the specially-shaped shaft; the rotating end is rotationally connected to the specially-shaped shaft; and a rotating ring, which is a ring-shaped component sleeving the outer circumference of the specially-shaped shaft, wherein one end of the rotating ring is fixedly connected to the rotating end of the code switch, and the other opposite end of the rotating ring is a free end; and the rotating ring is rotationally connected to the specially-shaped shaft.

Preferably, the rotating ring is detachably connected to the rotating end of the code switch through a buckle mechanism; the buckle mechanism comprises a limiting slot and a buckle slot which are provided in a circumferential wall surface of the rotating end of the code switch, and a limiting member and a buckle which are arranged on the rotating ring and respectively correspond to the limiting slot and the buckle slot; and when the rotating ring is integrally connected to the code switch, the limiting member is inserted into the limiting slot, and the buckle is buckled in the buckle slot.

Equipment using the above switch mechanism convenient for adjustment during holding is provided. The equipment includes an upper-end component and a lower-end component; the upper-end component and the lower-end component are integrally connected through the connecting member; an upper-end connecting part is arranged at a bottom of the upper-end component; a lower-end connecting part is arranged at a top of the lower-end component; an upper end of the connecting member is fixedly connected to the upper-end connecting part, and a lower end of the connecting member is fixedly connected to the lower-end connecting part; the specially-shaped shaft is arranged between the upper-end component and the lower-end component; the outer circumference of the specially-shaped shaft is enclosed with the upper-end component and the lower-end component to form an accommodating space in the circumferential direction; the code switch and the rotating ring both sleeve the outer circumference of the specially-shaped shaft and are arranged in the accommodating space; and the rotating ring is rotationally connected to the upper-end component and/or the lower-end component.

Preferably, the upper-end component is a fan head; the lower-end component is a fan handle; an upper end of the connecting member is fixedly connected to the fan head; a portion of a body of a lower end of the connecting member extends downwards to form the specially-shaped shaft; the lower-end connecting part is arranged at a top of the fan handle; a shaft seat is arranged on the lower-end connecting part; a lower end of the specially-shaped shaft is inserted into the shaft seat and is locked by a screw to achieve integrated connection to the fan handle; the code switch and the rotating ring sleeve the outer circumference of the specially-shaped shaft; the code switch is in limited connection with the connecting member; the rotating ring is connected to the rotating end at a lower end of the code switch; and a lower end of the rotating ring is slidably connected to an upper end portion of the fan handle and is able to rotate along an axis of the fan handle.

Preferably, the rotating ring is a light-transmitting member; the lower-end connecting part is a light-transmitting hood; a light emission panel is arranged below the light-transmitting hood; and a light emission direction of the light emission panel is towards one side where the rotating ring is located.

Preferably, a display screen assembly is arranged in the rotating ring; and displayed content of the display screen assembly is displayed through the rotating ring.

Preferably, the fan head includes a housing; an air duct is formed in the housing; two ends of the air duct are respectively configured to be an air inlet and an air outlet; an internal support is fixedly arranged in the air duct, and an air-air-driving fan blade group is mounted on one side of the internal support facing the air inlet; the air-driving fan blade group guides air located at the air inlet into the air duct and then blows the air out from the air outlet; and an air gathering hood surrounds the air-driving fan blade group in a circumferential direction.

Preferably, the air inlet is covered with an air inlet cover; the air outlet is covered with an air outlet cover; a through hole is provided in a middle position of the air outlet cover; a cold and heat semiconductor is embedded in the through hole; one side of the cold and heat semiconductor away from the air duct is covered with a conductive element, and one side of the cold and heat semiconductor away from the conductive element is connected with a heat dissipation element; and the conductive clement and the heat dissipation element are respectively connected to working surfaces of a cooling side and a heating side of the cold and heat semiconductor in a heat conduction manner.

Preferably, the fan handle includes a front shell, a rear shell, and a bottom shell; the front shell, the rear shell, the bottom shell, and the lower-end connecting part are enclosed to form a handle accommodating chamber; a storage battery and a circuit board assembly are mounted in the handle accommodating chamber; the storage battery is electrically connected to the circuit board assembly; the circuit board assembly is provided with a cooling switch, a power switch, and a USB port in an electrically connected manner; the cooling switch, the power switch, and the USB port are all arranged in preset through holes of the rear shell and extend outwards from the through holes.

Preferably, a bottom of the fan handle is rotationally connected with a carabiner.

Compared with the prior art, the present disclosure has the beneficial effects below:

When using the switch mechanism, handheld equipment can be conveniently adjusted with a single hand. Furthermore, by cooperation between the code switch and the rotating ring, the handheld equipment even can be steplessly adjusted at high precision, which can effectively enhance a user experience.

### BRIEF DESCRIPTION OF THE DRAWINGS

FIG. 1 is a structural exploded diagram I of the present disclosure;

FIG. 2 is a structural exploded diagram II of the present disclosure;

FIG. 3 is a structural exploded diagram III of the present disclosure;

FIG. 4 is a three-dimensional diagram of an appearance of the present disclosure;

FIG. 5 is a schematic structural diagram of a coder of the present disclosure; and

FIG. 6 is a schematic structural diagram of a rotating ring of the present disclosure.

In the drawings: 1: fan head; 11: upper-end connecting part; 12: conductive element; 13: cold and heat semiconductor; 14: heat dissipation element; 15: internal support; 16: air-driving fan blade group; 17: air gathering hood; 18: housing; 181: air inlet cover; 182: air outlet cover; 2: connecting member; 21: specially-shaped shaft; 3: code switch; 4: rotating ring; 5: display screen assembly; 6: fan handle; 61: lower-end connecting part; 611: shaft seat; 62: front shell; 63: rear shell; 64: bottom shell; 65: storage battery; 66: circuit board assembly; 661: cooling switch; 662: power switch; 663: USB port; 67: light emission panel; and 7: carabiner.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure.

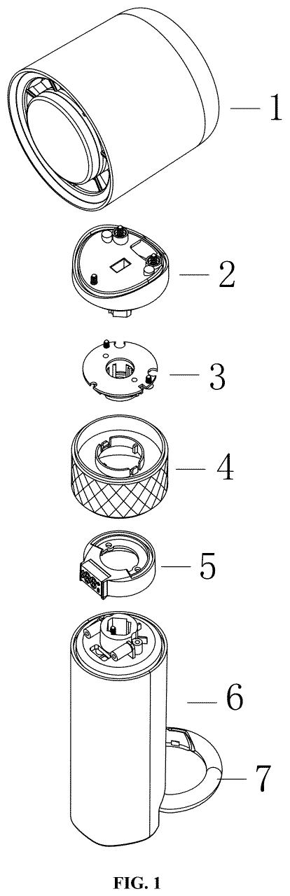

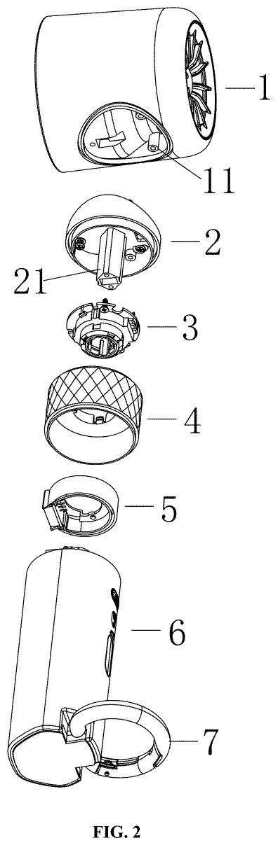

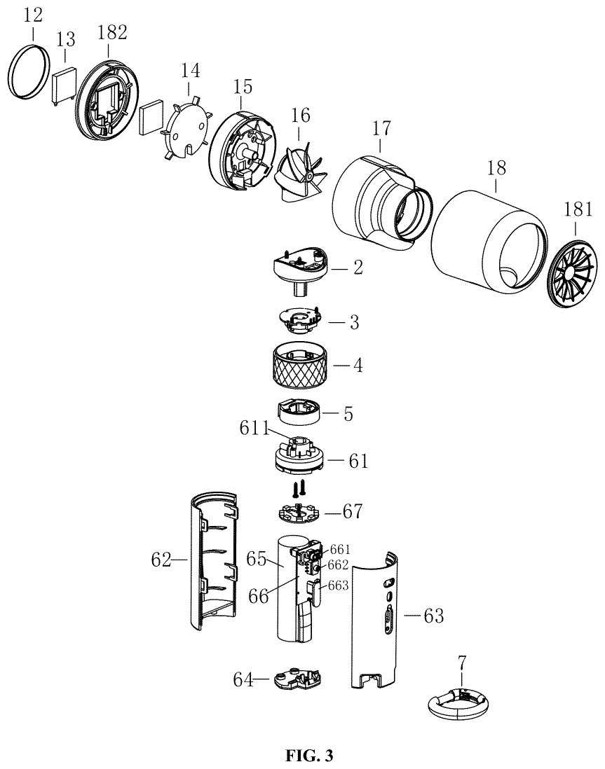

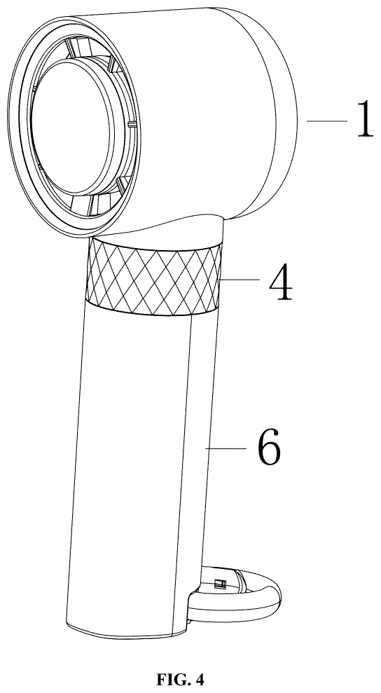

Referring to FIG. 1 to FIG. 6, equipment using a switch mechanism convenient for adjustment during holding is provided. The switch mechanism convenient for adjustment during holding includes: a connecting member 2, wherein the connecting member 2 is configured to connect two or more components, for originally separated components to be integrally connected, and a specially-shaped shaft 21 is arranged on the connecting member 2 in an integrated connection manner; a code switch 3, which includes a fixed end 31 and a rotating end 32, wherein the code switch 3 sleeves an outer circumference of the specially-shaped shaft 21, and the fixed end 31 is kept in fixed connection with the specially-shaped shaft 21; the rotating end 32 is rotationally connected to the specially-shaped shaft 21; and a rotating ring 4, which is a ring-shaped component sleeving the outer circumference of the specially-shaped shaft 21, wherein one end of the rotating ring 4 is fixedly connected to the rotating end 32 of the code switch 3, and the other opposite end of the rotating ring 4 is a free end; and the rotating ring 4 is rotationally connected to the specially-shaped shaft 21. When a finger pushes the rotating ring 4 to rotate, a binary coding signal is input to the code switch 3 to achieve an effect of adjusting a working level of the equipment.

In an appropriate embodiment, the equipment at least includes an upper-end component and a lower-end component. The upper-end component is a main body component for achieving main functions of the equipment, and the lower-end component is a handheld part for holding. The upper-end component and the lower-end component are integrally connected through the connecting member 2. An upper-end connecting part 11 is arranged at a bottom of the upper-end component; a lower-end connecting part 61 is arranged at a top of the lower-end component; an upper end of the connecting member 2 is fixedly connected to the upper-end connecting part 11, and a lower end of the connecting member 2 is fixedly connected to the lower-end connecting part 61; the specially-shaped shaft 21 is arranged between the upper-end component and the lower-end component; the outer circumference of the specially-shaped shaft 21 is enclosed with the upper-end component and the lower-end component to form an accommodating space; the code switch 3 and the rotating ring 4 both sleeve the outer circumference of the specially-shaped shaft 21 and are arranged in the accommodating space; and the rotating ring 4 is rotationally connected to the upper-end component and/or the lower-end component.

In this embodiment, the upper-end component is a fan head 1; the lower-end component is a fan handle 6; an upper end of the connecting member 2 is fixedly connected to the fan head 1; a portion of a body of a lower end of the connecting member 2 extends downwards to form the specially-shaped shaft 21; the lower-end connecting part 61 is arranged at a top of the fan handle 6; a shaft seat 611 is arranged on the lower-end connecting part 61; a lower end of the specially-shaped shaft 21 is inserted into the shaft seat 611 and is locked by a screw to achieve integrated connection to the fan handle 6; the code switch 3 and the rotating ring 4 sleeve the outer circumference of the specially-shaped shaft 21; the code switch 3 is in limited connection with the connecting member 2; the rotating ring 4 is connected to a rotating part 32 at a lower end of the code switch 3; and a lower end of the rotating ring 4 is slidably connected to an upper end portion of the fan handle 6 and is able to rotate along an axis of the fan handle 6. When the fan handle 6 is held in a hand, a finger pushes the rotating ring 4 to enable the rotating ring 4 to rotate to the left or to the right, so that a wind speed of the fan head I can be adjusted. Furthermore, by using the code switch 3, multi-stage linear gear shifting can be achieved. In the rotating process of the rotating ring 4, stepless adjustment of the wind speed can be achieved.

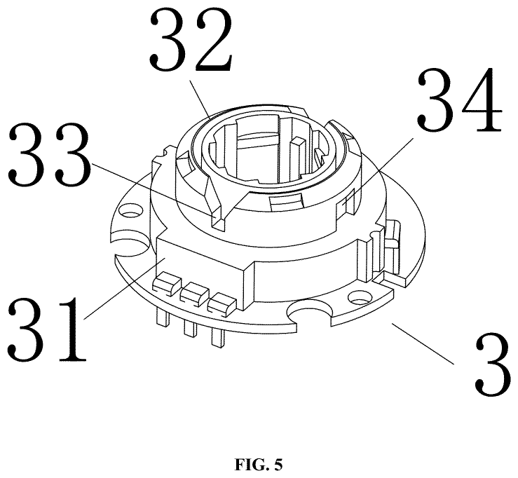

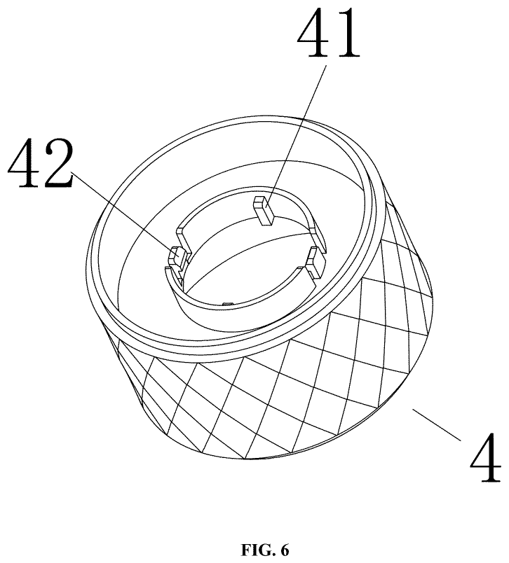

As shown in FIG. 5 and FIG. 6, the rotating ring 4 is detachably connected to the rotating end 32 of the code switch 3 through a buckle mechanism; the buckle mechanism includes a limiting slot 33 and a buckle slot 34 which are provided in a circumferential wall surface of the rotating end 32 of the code switch 3, and a limiting member 41 and a buckle 42 which are arranged on the rotating ring 4 and respectively correspond to the limiting slot 33 and the buckle slot 34; and when the rotating ring 4 is integrally connected to the code switch 3, the limiting member 41 is inserted into the limiting slot 33, and the buckle 42 is buckled in the buckle slot 34. Using this buckle mechanism is conductive to improve the convenience of assembling of a fan.

The rotating ring 4 is a light-transmitting member; the lower-end connecting part 61 is a light-transmitting hood; a light emission panel 67 is arranged below the light-transmitting hood; and a light emission direction of the light emission panel 67 is towards one side where the rotating ring 4 is located. When working, the light emission panel 67 can achieve a light rendering effect in a rotating ring region, so that the equipment body has a funnier appearance. A display screen assembly 5 is arranged in the rotating ring 4. The display screen assembly 5 is electrically connected to the circuit board assembly 66. The display screen assembly 5 can be configured to display information, such as a real-time working gear and an actual battery life of the storage battery 65, of the fan. Displayed content is displayed through the rotating ring 4.

The fan head 1 includes a housing 18; an air duct is formed in the housing 18; two ends of the air duct are respectively configured to be an air inlet and an air outlet; an internal support 15 is fixedly arranged in the air duct, and an air-air-driving fan blade group 16 is mounted on one side of the internal support 15 facing the air inlet; the air-driving fan blade group 16 guides air located at the air inlet into the air duct and then blows the air out from the air outlet; and an air gathering hood 17 surrounds the air-driving fan blade group 16 in a circumferential direction. The air gathering hood 17 increases the wind speed at the air outlet by gathering air to change a wind pressure. The air inlet is covered with an air inlet cover 181; the air outlet is covered with an air outlet cover 182; a through hole is provided in a middle position of the air outlet cover 182; a cold and heat semiconductor 13 is embedded in the through hole; one side of the cold and heat semiconductor 13 away from the air duct is covered with a conductive element 12, and one side of the cold and heat semiconductor 13 away from the conductive element 12 is connected with a heat dissipation element 14; and the conductive element 12 and the heat dissipation element 14 are respectively connected to working surfaces of a cooling side and a heating side of the cold and heat semiconductor in a heat conduction manner. When the cold and heat semiconductor 13 works, the working surface facing one side of the conductive element 12 achieves cooling, so that the conductive element 12 is cooled and can be in contact with the skin of a human body for cold compress care. According to the working principle of energy conservation of the cold and heat semiconductor 13, one side of the cold and heat semiconductor 13 facing the heat dissipation member 14 may generate heat when working. After being transferred onto the heat dissipation member 14, the heat cooperates with the air-driving fan blade group 16 to achieve quick heat dissipation, so that the impact on a cold compress care effect caused by the fact that the fan head 1 is heated by the heat accumulated in the air duct is avoided.

The fan handle 6 includes a front shell 62, a rear shell 63, and a bottom shell 64; the front shell 62, the rear shell 63, the bottom shell 64, and the lower-end connecting part 61 are enclosed to form a handle accommodating chamber; a storage battery 65 and a circuit board assembly 66 are mounted in the handle accommodating chamber; the storage battery 65 is electrically connected to the circuit board assembly 66; the circuit board assembly 66 is provided with a cooling switch 661, a power switch 662, and a USB port 663 in an electrically connected manner; the cooling switch 661, the power switch 662, and the USB port 663 are all arranged in preset through holes of the rear shell 63 and extend outwards from the through holes. The cooling switch 661 is configured to control switching on and switching off of a working state of the cold and heat semiconductor 13, and the power switch 662 is configured to control on and off states of a circuit of the air-driving fan blade group 16. After the circuit is on, the wind speed can be adjusted through the rotating ring 4 on the switch mechanism. When the USB port 663 is connected to an external power supply through a charging cable, the storage battery 65 can be charged to supplement electric energy.

A bottom of the fan handle 6 is rotationally connected with a carabiner 7. A fan body can be hung on a backpack or a waistband through the carabiner 7, which facilitates carrying and use outside.

In summary: When using the switch mechanism, handheld equipment can be conveniently adjusted with a single hand. Furthermore, by cooperation between the code switch and the rotating ring, the handheld equipment even can be steplessly adjusted at high precision, which can effectively enhance a user experience.

It should be noted that in this document, relationship terms such as first and second are used solely to distinguish one entity or operation from another entity or operation without necessarily requiring or implying any actual such relationship or order between such entities or operations. Furthermore, the terms “include”, “including”, or any other variation thereof, are intended to encompass a non-exclusive inclusion, such that a process, method, article, or device that includes a list of elements does not include only those elements but may include other elements not explicitly listed or inherent to such process, method, article, or device.

Although the embodiments of the present disclosure have been shown and described, it can be understood by those of ordinary skill in the art that various changes, modifications, substitutions, and variations can be made to these embodiments without departing from the principle and spirit of the present disclosure. The scope of the present disclosure is defined by the accompanying claims and their equivalents.

What is claimed is:

1. A switch mechanism convenient for adjustment during holding, comprising:
a connecting member (2), wherein the connecting member (2) is configured to connect two or more components, for originally separated components to be integrally connected, and a specially-shaped shaft (21) is arranged on the connecting member (2) in an integrated connection manner;
a code switch (3), which comprises a fixed end (31) and a rotating end (32), wherein the code switch (3) sleeves an outer circumference of the specially-shaped shaft (21), and the fixed end (31) is kept in fixed connection with the specially-shaped shaft (21); the rotating end (32) is rotationally connected to the specially-shaped shaft (21); and
a rotating ring (4), which is a ring-shaped component sleeving the outer circumference of the specially-shaped shaft (21), wherein one end of the rotating ring (4) is fixedly connected to the rotating end (32) of the code switch (3), and the other opposite end of the rotating ring (4) is a free end; and the rotating ring (4) is rotationally connected to the specially-shaped shaft (21).

2. The switch mechanism convenient for adjustment during holding according to claim 1, wherein the rotating ring (4) is detachably connected to the rotating end (32) of the code switch (3) through a buckle mechanism; the buckle mechanism comprises a limiting slot (33) and a buckle slot (34) which are provided in a circumferential wall surface of the rotating end (32) of the code switch (3), and a limiting member (41) and a buckle (42) which are arranged on the rotating ring (4) and respectively correspond to the limiting slot (33) and the buckle slot (34); and when the rotating ring (4) is integrally connected to the code switch (3), the limiting member (41) is inserted into the limiting slot (33), and the buckle (42) is buckled in the buckle slot (34).

3. Equipment using the switch mechanism convenient for adjustment during holding according to claim 1 or 2, wherein the equipment comprises an upper-end component and a lower-end component; the upper-end component and the lower-end component are integrally connected through the connecting member (2); an upper-end connecting part (11) is arranged at a bottom of the upper-end component; a lower-end connecting part (61) is arranged at a top of the lower-end component; an upper end of the connecting member (2) is fixedly connected to the upper-end connecting part (11), and a lower end of the connecting member (2) is fixedly connected to the lower-end connecting part (61); the specially-shaped shaft (21) is arranged between the upper-end component and the lower-end component; the outer circumference of the specially-shaped shaft (21) is enclosed with the upper-end component and the lower-end component to form an accommodating space; the code switch (3) and the rotating ring (4) both sleeve the outer circumference of the specially-shaped shaft (21) and are arranged in the accommodating space; and the rotating ring (4) is rotationally connected to the upper-end component and/or the lower-end component.

4. The equipment using the switch mechanism convenient for adjustment during holding according to claim 3, wherein the upper-end component is a fan head (1); the lower-end component is a fan handle (6); an upper end of the connecting member (2) is fixedly connected to the fan head (1); a portion of a body of a lower end of the connecting member (2) extends downwards to form the specially-shaped shaft (21); the lower-end connecting part (61) is arranged at a top of the fan handle (6); a shaft seat (611) is arranged on the lower-end connecting part (61); a lower end of the specially-shaped shaft (21) is inserted into the shaft seat (611) and is locked by a screw to achieve integrated connection to the fan handle (6); the code switch (3) and the rotating ring (4) sleeve the outer circumference of the specially-shaped shaft (21); the code switch (3) is in limited connection with the connecting member (2); the rotating ring (4) is connected to the rotating end (32) at a lower end of the code switch (3); and a lower end of the rotating ring (4) is slidably connected to an upper end portion of the fan handle (6) and is able to rotate along an axis of the fan handle (6).

5. The equipment using the switch mechanism convenient for adjustment during holding according to claim 4, wherein the rotating ring (4) is a light-transmitting member; the lower-end connecting part (61) is a light-transmitting hood; a light emission panel (67) is arranged below the light-transmitting hood; and a light emission direction of the light emission panel (67) is towards one side where the rotating ring (4) is located.

6. The equipment using the switch mechanism convenient for adjustment during holding according to claim 5, wherein a display screen assembly (5) is arranged in the rotating ring (4); and displayed content of the display screen assembly (5) is displayed through the rotating ring (4).

7. The equipment using the switch mechanism convenient for adjustment during holding according to claim 4, wherein the fan head (1) comprises a housing (18); an air duct is formed in the housing (18); two ends of the air duct are respectively configured to be an air inlet and an air outlet; an internal support (15) is fixedly arranged in the air duct, and an air-air-driving fan blade group (16) is mounted on one side of the internal support (15) facing the air inlet; the air-driving fan blade group (16) guides air located at the air inlet into the air duct and then blows the air out from the air outlet; and an air gathering hood (17) surrounds the air-driving fan blade group (16) in a circumferential direction.

8. The equipment using the switch mechanism convenient for adjustment during holding according to claim 7, wherein the air inlet is covered with an air inlet cover (181); the air outlet is covered with an air outlet cover (182); a through hole is provided in a middle position of the air outlet cover (182); a cold and heat semiconductor (13) is embedded in the through hole; one side of the cold and heat semiconductor (13) away from the air duct is covered with a conductive element (12), and one side of the cold and heat semiconductor (13) away from the conductive element (12) is connected with a heat dissipation element (14); and
the conductive element (12) and the heat dissipation element (14) are respectively connected to working surfaces of a cooling side and a heating side of the cold and heat semiconductor in a heat conduction manner.

9. The equipment using the switch mechanism convenient for adjustment during holding according to claim 4, wherein the fan handle (6) comprises a front shell (62), a rear shell (63), and a bottom shell (64); the front shell (62), the rear shell (63), the bottom shell (64), and the lower-end connecting part (61) are enclosed to form a handle accommodating chamber; a storage battery (65) and a circuit board assembly (66) are mounted in the handle accommodating chamber; the storage battery (65) is electrically connected to the circuit board assembly (66); the circuit board assembly (66) is provided with a cooling switch (661), a power switch (662), and a USB port (663) in an electrically connected manner; the cooling switch (661), the power switch (662), and the USB port (663) are all arranged in preset through holes of the rear shell (63) and extend outwards from the through holes.

10. The equipment using the switch mechanism convenient for adjustment during holding according to claim 9, wherein a bottom of the fan handle (6) is rotationally connected with a carabiner (7).
